(19) United States
(12) Patent Application Publication
(10) Pub. No.: US 2018/0124194 A1
(43) Pub. Date: May 3, 2018

(54) SYSTEM AND METHOD FOR A SUBSCRIPTION SERVICE IN A SERVERLESS ENVIRONMENT

(71) Applicant: Whalerock Industries, LLC, West Hollywood, CA (US)

(72) Inventor: Jeff Rajewski, West Hollywood, CA (US)

(73) Assignee: Whalerock Industries, LLC, West Hollywood, CA (US)

(21) Appl. No.: 15/342,903

(22) Filed: Nov. 3, 2016

(51) Int. Cl. H04L 29/08; H04L 29/06

(52) U.S. Cl. CPC H04L 67/26; H04L 63/10; H04L 63/08; H04L 67/20

(57) ABSTRACT

Methods and systems for implementing a serverless subscription service. A serverless subscription system can receive, from a user device, a subscription receipt, the subscription receipt having been issued by a third party. The serverless subscription system can authenticate the user as a valid subscriber, then map a user and device identification to the subscriber. The serverless subscription system can then store the mapping in a subscriber database, allowing a subscriber list to be built which is agnostic regarding third party subscription providers.

### BACKGROUND

### Technical Field

The present disclosure relates to software based digital content subscription services and more specifically to improvements in software based digital content subscription services through a serverless architecture.

### Introduction

Social media allows individuals, companies, governments, and other organizations to quickly and easily share information. For many individuals, such as celebrities, social media provides a platform through which they may have personal, direct, and engaging communications with the public. This intimacy can allow the public to have unprecedented access to the life of the posting individuals. However, due to privacy and security concerns, distinct capabilities, and varied opportunities for monetization, the individuals posting to social media must evaluate which aspects and types of social media best fit their lifestyle and business goals.

### SUMMARY

Disclosed are systems and methods for operating a digital content subscription service using a serverless architecture. In one configuration, a method for performing concepts disclosed herein can include: receiving, from a user device and at a serverless computing system operating a subscription service , a subscription receipt, the subscription receipt having been issued by a third party; authenticating, by the serverless computing system interacting with the third party to verify the subscription receipt, that the user device is associated with a valid subscriber, to yield an authentication; after the authenticating and via the serverless computing system, mapping at least one of a user identification and a device identification to the subscriber, to yield a mapping; and storing, via the serverless computing system, the mapping in a subscriber database.

In another configuration, a serverless subscription service can be configured to perform operations according to concepts disclosed herein, the exemplary operations including: receiving, from a user device, a subscription receipt, the subscription receipt having been issued by a third party; authenticating, by interacting with the third party to verify the subscription receipt, that the user device is associated with a valid subscriber, to yield an authentication; after the authenticating and via the serverless computing system, mapping at least one of a user identification and a device identification to the subscriber, to yield a mapping; and storing the mapping in a subscriber database.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example flow diagram for how individuals can upload content for a subscriber service;

FIG. 2 illustrates an example flow diagram for how subscribers can produce video comments on content uploaded by a user;

FIG. 3 illustrates exemplary data paths for verifying data associated with subscribers;

FIG. 4 illustrates an exemplary computer architecture;

FIG. 5 illustrates an exemplary microservices architecture; and

FIG. 6 illustrates an example method embodiment.

### DETAILED DESCRIPTION

The present disclosure addresses a subscription service in a serverless environment. More specifically, the subscription services disclosed herein are Internet-based subscription services where subscribers access content behind a paywall. To access the content, subscribers pay a subscription fee, receive a subscription receipt, and then use that subscription receipt to open the paywall. However, problems exist with this subscription model.

For example, at present the majority of consumers who purchase digital content subscriptions do so as in-app purchases made directly through platform-specific application stores, such as iTunes® for APPLE platform devices, Google Play™ and Amazon Appstore for Android™ platform devices, and so on. A user pays for the subscription through the platform-specific application store belonging to a third party (i.e., APPLE, GOOGLE, MICROSOFT, SONY, AMAZON, etc.), the third party receiving a percentage of the subscription price, the subscription service receiving the remainder of the subscription price, while the user receives access to the content. However, subscriber information provided to the subscription service by iTunes®, Google Play™, and other vendors lacks the level of detail needed for a subscription service to make informed decisions regarding user behavior. Instead, the reports issued by these third parties provides statistics such as “Active Subscriptions”, “Active Free Trials”, and “Last 30 Days Subscription Revenue”. Such data, while useful, fails to provide managers of a subscription service with sufficient information to determine information about the overall LifeTime Value (LTV) of users (either individually or in aggregate, as part of a cohort of subscribers). For example, to calculate the LTV of a subscriber, the subscriber service may need to know information such as the date the subscriber initially subscribed, what marketing or promotional campaign led to the subscription conversion, the price paid for the subscription, whether or not the subscription auto-renews, what period of time must elapse before the auto-renewal should be attempted, how many renewal periods the subscriber authorized, and/or when the subscriber cancelled or ended their subscription. Based on that information, the subscription service can calculate the amount of money the subscriber paid the subscription service over their lifetime, subtract a per-capita overhead amount as well as any other costs associated with the subscriber, and determine how much the subscription service earned from that subscriber.

Two common models for operating subscription services are an enterprise computing model and a commercial platform-as-a-service solution. In an enterprise computing model, the owners of a subscription service own one or hundreds of servers to host the subscription service content, manage functions, and otherwise provide services for the subscription service. Such enterprise computing models are, traditionally, poorly utilized. For example, the owner of the servers must constantly pay for maintenance, upgrades, physical protection, etc., of the servers, while the servers themselves may be in an idle state for a majority of the time, peaking only on rare occasions. If the servers lack capacity, it can result in a crashed website, application, etc. Therefore, the enterprise model architecture therefore presents two problems for subscription services: (1) cost for underutilized systems and (2) lack of scalability. The commercial platform-as-a-service solution takes the opposite approach by outsourcing maintenance and management of all technology, which leaves the subscription company subject to the reporting/analyses that the solution provider wishes to provide.

The present disclosure addresses the problems of a lack of comprehensive and uniform data being provided across all third party digital subscription sales channels, and the buildout and maintenance costs of owned enterprise hardware and software, by providing subscription content through a serverless subscription service. The subscription service utilizes web services, such as AMAZON WEB SERVICES (AWS), to perform functions and operations. While the web services utilize computers and servers to operate, use of such services is considered “serverless” because the subscription service itself does not own, maintain, or operate the servers. Instead, the subscription service pays the web service for when subscription service operations are being performed by the web service servers. The web service can have the ability to load balance as needed, allowing the subscription service to scale according to need in real-time (i.e., within minutes or seconds), while only paying for time where operations of the subscription service are being performed by the web service servers.

To address the problem of the third party sales channels not providing uniform and sufficient information about app users who purchase subscriptions from them, systems configured according to this disclosure can utilize verification tools to record data about the user/potential subscriber and the device the user is using to access the subscription service. For example, as a subscriber purchases a subscription through the third party sales channel, the subscriber may receive a subscription receipt (or an equivalent of such a receipt) from the third party and store that receipt on their phone, tablet, computer, or other device. If the subscriber uses another device which is tied to the third party, the subscription receipt can be received on that device as well. As the subscriber seeks to access the subscription content, the subscriber's device will present, to the subscription service, the subscription receipt.

Because there are abusers of such systems, the third parties (i.e., APPLE and GOOGLE) have created Application Programming Interfaces (APIs) allowing subscription services to verify the legitimacy of subscription receipts. The APIs allow the subscription service to verify, by interacting with the third party, that the subscription receipt is valid. In addition to verifying the legitimacy of the subscription receipt, the third party APIs provide to the subscription service identifying information about the subscriber and/or the device attempting to access the subscription service. Non-limiting examples of identifying information obtained by the subscription service can include a subscriber identification (“subscriber ID”) of the subscriber (the subscriber ID being specific to the sales channel involved in establishing the subscription), a device identification (the device identification being specific to the user's device platform), a subscription date when the subscriber first purchased the subscription and/or when the subscription receipt was issued and/or received, a subscription product (if there are multiple tiers of subscription access), and/or a subscription channel (APPLE, ANDROID, AMAZON, etc.).

If the subscription receipt is verified, by the third party via the third party API, as legitimate, subscription services configured according to this disclosure can record information skimmed from verification API processes and record that information in a database. Regardless of whether a subscriber ID or device ID is provided by the API, the subscription service will generate an identification native to the service by which that subscriber will be primarily identified and add the skimmed data, in addition to other data generated by the subscription service about the user, as well as any data volunteered by the users about themselves, to the subscriber's record in the service.

Systems configured according to this disclosure can record the information skimmed from the API and record that data in a database. This is not the original intention of the verification APIs. However, by using the APIs in a manner not originally intended, the subscriber service can build a database mapping key data about individual subscribers in a manner which transcends third party reporting, and allows the subscriber service to build a subscriber database which is agnostic of which third parties the subscriptions are purchased from. For example, the subscriber service can record information about a first subscriber who purchased the subscription through iTunes®, and also record information about a second subscriber who purchased the subscription through Google Play™, in a single table or database.

The data recorded by the service can establish relationships between a user, their devices, their subscriptions, and their entitlements (e.g. specifically what digital content they are entitled to access over what period of time). The subscription service can expand on this initial data capture by attaching data from transactions conducted by the user with the app, regardless of what sales channel(s) they may have transacted with, such that the subscription service can at any time “replay” any given user's complete transactional history and tell a story (either on an individual or aggregated basis) of how the users moved through various conversion events. For example, subscription service managers might look at subscribers added in the month of July, or subscribers who purchased the subscription using a coupon, or subscribers added within a certain number of days after an advertising campaign began, or subscribers added after specific types of content are posted, etc. In many cases, the subscriber services disclosed herein can be associated with one or more individuals, celebrities, other “Talent”, companies, etc., who post content. To cover all of these entities, posting bodies can be referred to as a “Poster.” In such cases, the statistics generated can also be based on which individual posted the content (if more than one person can post content), interactions with the media (i.e., if the Poster made headlines, how does that affect subscribership?), sales in other media associated with the Poster (for example, record sales, movie sales), comments in other Social Media (Facebook®, Snapchat, etc.).

In addition, systems configured according to this disclosure can utilize the serverless architecture to post video comments regarding specific subscription content. For example, when the Poster posts a video, subscribers can post their own video comment to the subscription system, where the video comment can be cleared by a moderator, then posted for other subscribers to view. The other subscribers (as well as the Poster) can then respond to the video comment, upvote the comment, downvote the comment, report the comment, and otherwise interact with the comment, thereby creating an environment where subscribers can post videos (rather than just text or audio) of their thoughts and feelings regarding the Poster's post.

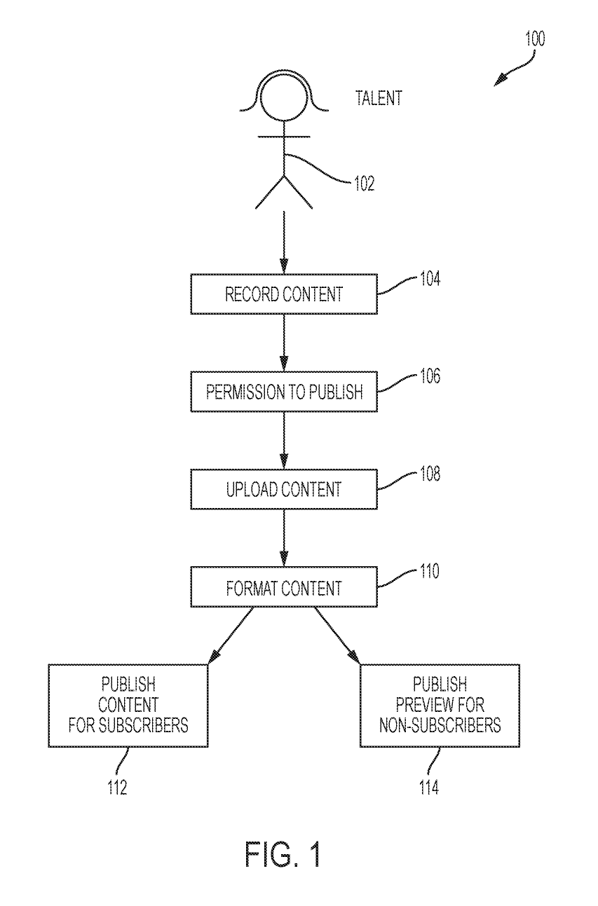

Such examples are non-limiting, and present exemplary features which systems configured according to this disclosure may utilize. These and other features will be discussed further as the illustrations are presented. It is noted that the systems and methods disclosed herein are exemplary only, and individual portions of the exemplary configurations provided herein may be combined (or removed) as necessity requires. With this general understanding of the concepts disclosed herein, the disclosure turns to specific examples found in FIGS. 1-6.

FIG. 1 illustrates an example flow diagram 100 for how individuals can upload content for a subscriber service. In this example 100, the Poster 102 uploading content to a subscriber service is referred to as “Talent”. Examples of a Talent may include a celebrity or someone associated with a celebrity, where the subscriber service is focused on presenting content posted by the Poster 102. In other configurations, the Poster 102 illustrated can be representative of a business, a team (such as a sports team), a brand, a government entity, an individual who desires their own subscription service, or other organizations.

The Poster 102 (having been authenticated to the subscriber service as a valid Poster 102)records content 104, with non-limiting examples of such content including a picture, a video, an audio stream, a link or notification associated with a product, a link or notification associated with a business or location (such as a restaurant), and/or any other postable content. Upon recording the content, the Poster 102 confirms the publication of the content 106 to the subscription service, at which point the content is uploaded 108 to the subscription service from the device of the Poster 102. Examples of a device from which the Poster 102 uploads the content to the subscription service can include smartphones, tablets, laptops, computers, smart wearables (such as smart watches, smart ear pieces, smart glasses, smart contacts, etc.). The subscription service then formats the content 110 and publishes the content 112 so subscribers (and, at the discretion of subscription service managers, non-subscribers) can view the content. In certain configurations, the subscription service may also generate a preview for non-subscribers 114. For example, the preview of a 20 second video may be clipped at 10 seconds, the preview of a picture may display for 15 seconds and then become non-viewable unless the previewer purchases a subscription, and a review of a product may not provide the name of the product being reviewed.

With the content published to the subscription service 112, subscribers can begin interacting with the content. In some cases, this interaction is simply viewing the content, whereas in other cases the subscriber may wish to leave a text comment, leave a video comment, “like”, upvote, downvote, and/or otherwise interact with the content.

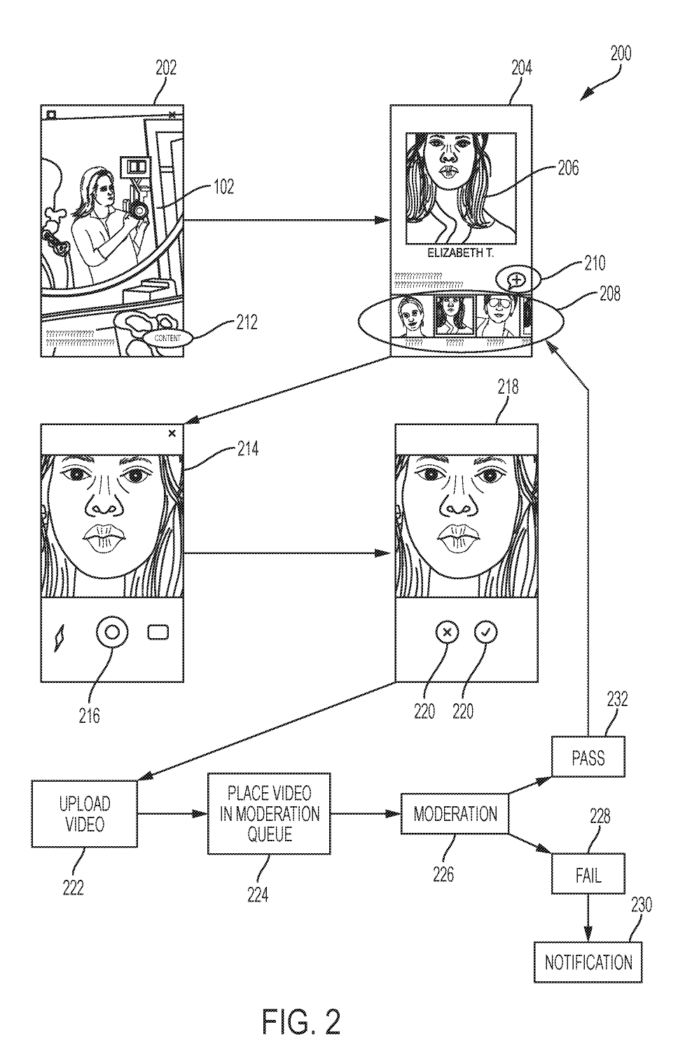

FIG. 2 illustrates an example flow diagram 200 for how subscribers can produce video comments on content 202 uploaded by the Poster 102. While the illustration 200 is specific to video commenting, the principles and moderation aspects can be applied to other types of interaction as well. As illustrated, the subscriber can view the content 202 posted by the Poster 102, with an option to view and/or make comments 212, or otherwise interact with the content. When the subscriber chooses to interact with the content 202 via the comment button 212, a window 204 appears, illustrating a profile picture 206 of the subscriber and/or a thumbnail of a previously recorded and uploaded video comment, thumbnails of other subscribers 208 who have already interacted with the posted content 202 (i.e., uploaded video comments about the content), and an option to add a video comment 210.

When the subscriber presses the option to add a video comment 210, the subscriber is presented a live view 214 from the camera of their device. For example, if the user is using a smartphone, the camera selected for the video commenting can automatically be selected to be the user-facing camera, such that the display shows the subscriber in the live view 214. The subscriber is also presented with a record button 216. The record button 216 can be configured such that a single press results in the user's device taking a picture of the subscriber, whereas holding the record button 216 down results in video being recorded. After the subscriber records a message such as a video comment, the message 218 can then be presented to the subscriber for review, along with options to delete or upload 220 the message.

In this configuration, when the subscriber chooses to upload the video comment by pressing the “check” button of the delete/upload options 220, the video is uploaded 222 to the subscription system and placed in a moderation queue 224 for review. The moderation 226 takes place, ensuring that the video comment meets certain standards and protocols, such as a lack of predetermined words, being on point with the content 202, and otherwise not “trolling” the Poster 102. Such moderation 226 can be performed by a human being acting on behalf of the subscription service, or can be performed by an automated moderation system.

Such automated moderation systems can use a combination of visual recognition techniques and speech recognition techniques to ensure a lack of inappropriate content. For example, the visual recognition technique may analyze individual frames of the video comment for content such as nudity, inappropriate words on t-shirts, etc. Likewise, the speech recognition technique may perform speech recognition on the audio recorded in the video, generate a transcript based on the speech recognized, and compare the words found in the transcript to a list of appropriate/inappropriate words.

If the moderation 226 determines that the video comment fails 228, a notification 230 can be issued for the subscriber informing the subscriber why the video comment was not approved. In some configurations, no notification is sent out when the video comment fails 228 by a moderator. Indeed, in such configurations, it may appear published to the subscriber but not appear to others. If the moderation 226 determines that the video comment passes 232, the video comment can be added to the list of thumbnails 208 which fellow subscribers will see when interacting with the content 202. In certain configurations, the moderation approval can result in a notification being sent to the subscriber.

The recording can have certain limits in quality and/or length. For example, the system may limit the length of the video comment to 10, 20, or 30 seconds. In addition, subscribers can be limited on the number of comments they are allowed to leave for each piece of content 202 the Poster 102 posts. In some cases, these limits can vary based on a status of the subscriber. Consider the case where a subscriber leaves a video comment on each and every piece of content the Poster 102 posts. In such cases, the system could be configured to promote or otherwise raise the status of the subscriber such that their reputation allows them to leave longer comments. Similarly, if enough fellow subscribers upvote a video comment of a subscriber, that subscriber can be granted increased rights/privileges (such as longer video comments, being boosted to the front of the moderation queue, special notifications regarding posted content, etc.). If enough fellow subscribers downvote a video comment of a subscriber, that subscriber could see their rights/privileges diminished back to a baseline level. If the Poster 102 were to respond to a subscriber's video comment, the subscriber could have their rights/privileges permanently or temporarily increased with respect to that content or all content. For example, if the Poster 102 responded to a video comment posted by a subscriber, the system could allow that subscriber to post an additional video comment, the system could allow the next post to be made with a longer time limit (such as 1 or 2 minutes rather than 10 seconds). By limiting the number and length of the comments which subscribers are allowed to make, an “economy” is created, where the subscribers shouldn't want to waste an opportunity to comment (since they can only post a pre-determined number of comments per piece of content), while at the same time encouraging participation (either through the intrinsic act of participating or by providing rewards for participation).

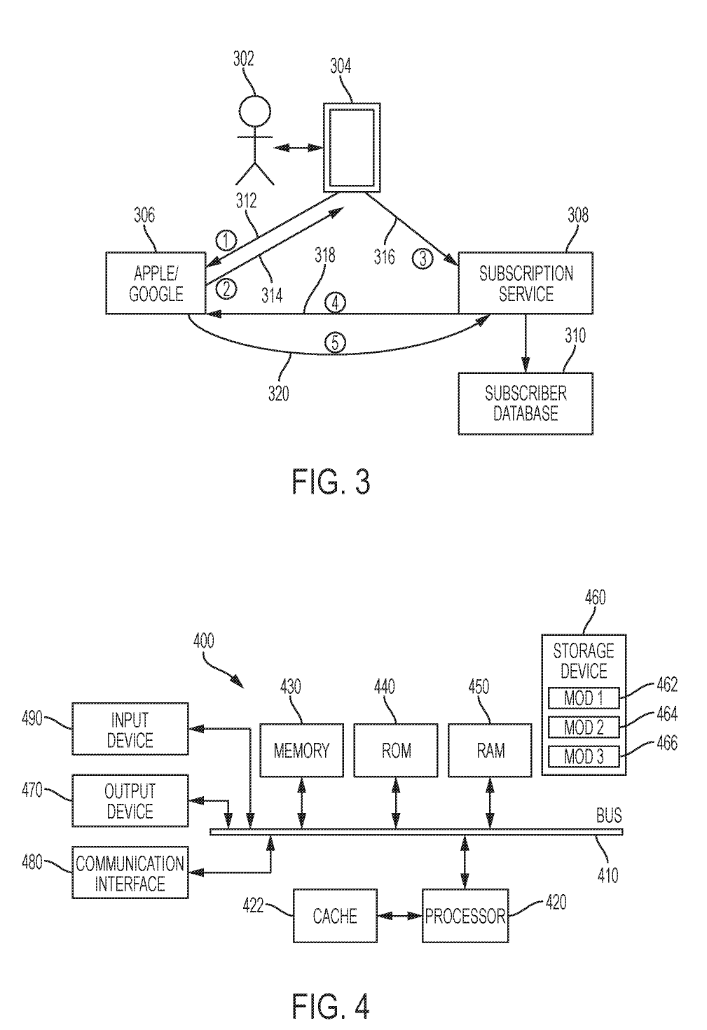

FIG. 3 illustrates exemplary data paths for verifying a subscriber 302 as valid (meaning their subscription is up-to-date). Specifically, this process allows the subscription service 308 to verify that the subscription receipt being presented to access the subscription content is legitimate. For clarity of explanation, numerals (1)-(5) are illustrated and described below, the numerals showing the order of communications in the subscription verification process. In certain configurations, various steps described with respect to FIG. 3 may be skipped, altered, or performed in a distinct order than described herein.

The subscriber 302 interacts with a subscriber device 304, which can include a smartphone, laptop, computer, smartphone, smart wearable device (such as a smart watch or smart ear piece), or other computing device. Through the subscriber device 304, the subscriber 302 purchases (1) 312 a subscription to the subscription service 308 via in-app purchase through a third party 306, such as APPLE or GOOGLE using iTunes® or Google Play™, respectively. The third party 306 returns (2) 314 a subscription receipt to the subscriber device 304, which stores the subscription receipt. When the subscriber 302 seeks to access the subscription service 308, the subscriber device 304 presents (3) 316 the subscription receipt to the subscription service 308. The subscription service 308 initiates an API provided by the third party 306 to verify the validity of the subscription receipt.

In this illustration, the subscription service 308 uses the API to verify (4) 318 the legitimacy of the subscriber's receipt by contacting the third party 306. In doing so, the subscription service 308 skims data about the subscription 312 from the API, allowing a set of relational database records to be established describing the user, their device(s), their subscription(s) and their entitlement(s). While this is not the intended purpose of the verification API, using it this way allows data to be obtained and accrued about the subscriber 302. For example, when the third party 306 returns (5) 320 a verification that it is a legitimate receipt, the record of skimmed data is recorded by the subscription service 308 in a subscriber database 310. The database 310 can be a single storage unit or a number of databases. For example, there can be one database 310 purely for user data (user IDs, email addresses and passwords). Another database 310 can be specific to subscriptions (user IDs, subscription ID, subscription product, subscription sales channel). Yet another database can be for subscription transactions (all transactions attached to a subscription ID). The data stored in the database(s) 310 can be agnostic regarding which third party 306 issued the subscription. Some non-limiting exemplary pieces of information which can be stored include subscriber device 304 identification, type of device, and the date the subscription was purchased. Other exemplary data associated with the subscriber which can also be obtained using the API and subsequently stored can include: a full transaction history (i.e., all purchases, renewals, upgrades, downgrades, and non-renewals), a status history (which can include time periods where the subscription was active or lapsed, with sub-statuses of ‘created,’ ‘renewed,’ ‘renewal not found,’ ‘cancelled,’ etc., and an indication of whether the status was changed by the system or by a human (such as customer care agent). If authorized by the subscriber, data such as email address, profile picture, notification preferences, etc., can also be obtained from API usage or, if not obtained via use of the API, generated by the subscriber service.

Exemplary data which can be obtained about the user's device can include the make and model of the device, the OS version, the app version. There are additional, more complex kinds of data which can be associated with to the user—for example, which marketing segments the user falls into, cohorts (groups formed by when the user first subscribed), if the user previewed the content before subscribing using a visitor ID, type of content viewed generally viewed by the subscriber, etc. The net result of this data aggregation is the ability to “replay” activities of users and subscribers, transaction by transaction—whether those transactions take the form of subscription purchases, e-commerce purchases, video plays, article displays, ad clicks, video comments, etc. In addition to the replay ability, the data can be used to analyze users and execute highly targeted messaging, retention strategies, conversion strategies, etc., based on user behavior of groups or individuals. Lastly, in addition to being able to analyze individual user behavior or target subscribers individually with messaging based on that behavior, this data can be used to study subscribers in aggregate, particularly with critical financial analyses such as LTV, churn reporting, and survivor analysis.

With the data about the subscriber 302 recorded in the subscriber database 310, the subscription service 308 can periodically rerun the API (steps (4) 318 and (5) 320), thereby determining if the subscription receipt and/or subscriber device 304 are still able to be verified as valid. By re-executing the API after the subscription receipt and/or device 304 have already been confirmed as valid, the subscription service 308 is able to update data in the subscriber database 310. This data allows managers of the subscription service 308 to calculate the lifetime value of subscribers 302, individually or in aggregated segments/cohorts, dimensionalized on factors such as purchase date, cancel date, marketing/promotion that earned the conversion, sales channel, current macro-economic or cultural trends, and others to be determined (the subscription service supporting such elastic segmentation as a basic operating requirement). In other words, by re-executing the API on or near the date of the subscription renewal (i.e., weekly, monthly, yearly, etc.), or every time the subscriber 302 logs into the subscription service, the subscription service can maintain an accurate record of how many and which users are subscribers, via which sales channels, to which subscription products; and append to this record other data generated by the service itself about each user. The end result is a set of data that allows managers to learn how individual subscribers behave and the basis for that behavior.

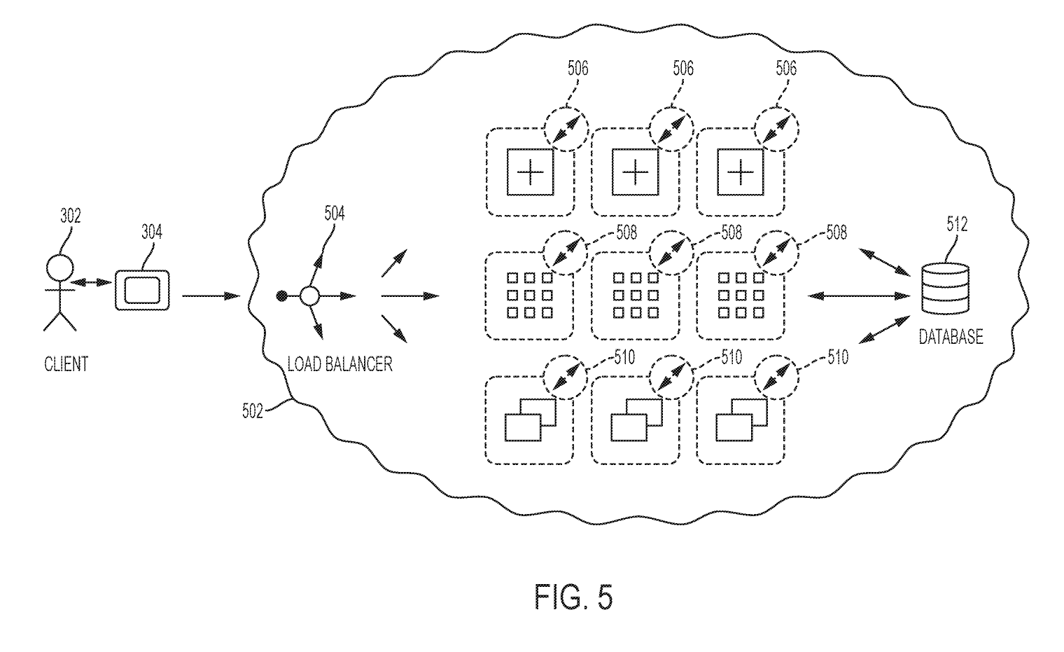

The subscriber service 308 can use a serverless architecture to perform the various operations associated with the service. A serverless architecture is a computing architecture based on use of cloud-based web services. The disclosure next describes a basic computing structure in FIG. 4, then expands the basic computing structure of FIG. 4 by describing a serverless architecture in FIG. 5.

With reference to FIG. 4, an exemplary system 400 includes a general-purpose computing device 400, including a processing unit (CPU or processor) 420 and a system bus 410 that couples various system components including the system memory 430 such as read only memory (ROM) 440 and random access memory (RAM) 450 to the processor 420. The system 400 can include a cache 422 of high speed memory connected directly with, in close proximity to, or integrated as part of the processor 420. The system 400 copies data from the memory 430 and/or the storage device 460 to the cache 422 for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as Mod 1 462, Mod 2 464, and Mod 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, output device 170 (such as a display), and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, and/or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 420. The functions these blocks represent may be provided through the use of either shared or dedicated hardware, including, but not limited to, hardware capable of executing software and hardware, such as a processor 420, that is purpose-built to operate as an equivalent to software executing on a general purpose processor. For example the functions of one or more processors presented in FIG. 4 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 440 for storing software performing the operations described below, and random access memory (RAM) 450 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 400 shown in FIG. 4 can practice all or part of the recited methods, can be a part of the recited systems, and/or can operate according to instructions in the recited tangible computer-readable storage media. Such logical operations can be implemented as modules configured to control the processor 420 to perform particular functions according to the programming of the module. For example, FIG. 4 illustrates three modules Mod 1 462, Mod 2 464 and Mod 3 466 which are modules configured to control the processor 420. These modules may be stored on the storage device 460 and loaded into RAM 450 or memory 430 at runtime or may be stored in other computer-readable memory locations.

FIG. 5 illustrates an exemplary “serverless” microservices architecture capable of running the subscription service 308 architecture of FIG. 3. In this example, the microservices architecture is operated by a web service operating in the cloud 502 (such as AMAZON Web Services) on a network of addressable nodes. The web service may be a single Internet site, multiple servers, or other user interface offered over a network. The web service may be implemented using multiple microservices that may be responsible for handling individual aspects of the overall web service, where the users/developers determine which functions need to be implemented by the web service. For example, a subscriber service such as described herein can perform operations for uploading content from Poster 102, verifying a subscription receipt from a subscriber's device 304, providing content to the subscriber's device 304, adding information about the subscriber 302 to a subscriber database 310, removing information about the subscriber 302 from the subscriber database 310, compiling information about subscribers, etc., by disparate microservices from different addressable nodes within the web service. Each addressable node may be an active electronic device (such as a server or other computing device) that is attached to a network, and is capable of sending, receiving, processing, or forwarding information over a communications channel.

The microservices architecture may include load balancer 504 for routing a request from one addressable node to one or more virtual addresses, where the virtual addresses can respectively correspond to microservices 506, 508, 510. The load balancer 504 may be an addressable node as well, or it may simply be software executing on an addressable node. The virtual addresses may be associated with the load balancer 504, and each virtual address may correspond to a unique microservice 506, 508, 510. A microservice may be any type of software service offered by a node on the network 101. In this exemplary architecture, virtual addresses are associated with microservices 506, 508, 510, respectively. The system 100 also comprises one or more physical nodes. The physical nodes may be implemented using any desired computing device, such as a network server, personal computer, or other device per the description provided in FIG. 4. Each physical node can supports one or more of the microservices by executing software associated with the microservice.

In one example, a single physical node can support microservices 506, 508, while a distinct physical node supports microservices 510. Each of the microservices 506, 508, 510 can be associated with a virtual address, which in turn can be associated with a physical node. Requests for the service of a particular microservice 506, 508, 510 may be addressed to the virtual address associated with the desired microservice.

Because the microservices 506, 508, 510 are provided by a web service on the cloud 502, such services are also described as “serverless.” While servers may be used by the web service to perform the desired operations, and may be informed which operations to perform by a central server (such as the load balancer 504 or a subscription service specific server for load balancing), the microservices architecture is described as serverless because the users of such services do not own, maintain, or otherwise have access to the servers used for the processing. Instead of paying to configure, upgrade, and otherwise maintain a server farm to host their operations, the users of serverless systems pay the web service for time when a processor is actually performing the desired operations (many web services also charge for other miscellaneous operations, such as uploading a new function or operation).

By not owning the servers which are performing the operations, the managers of applications which utilize serverless architectures can save money and resources because they are only paying for when operations are actually occurring, and not paying for servers when operations are idling. In addition, the serverless architecture can allow scaling of resources based on demand. For example, in a traditional server-farm architecture, each server may be configured to handle a single iteration or operation of functions 506, 508, 510. However, there may be instances where demand for a single type of operation is high, such as when many users are registering for a subscription service. When demand for operations outstrips the resources available (i.e., the number of servers owned, or the capacity of those servers), the website or application crashes. By contrast, in a serverless environment, resources are allocated based on demand, such that a subscription service makes demand of a single execution of a first operation type 506, no executions of a second operation type 508, and many executions of a third operations type 510. As demand increases for the third operations type 510, the number of demands for operations may exceed the number of operations any single server would be capable of executing. To compensate for this, the web service can use the load balancer 504 to shift operations between multiple servers. Each server can be communicating with a database 512 or databases to store data associated with the operations and/or a record of the operations.

Consider the example of implementing the video commenting process of FIG. 2 in the serverless architecture of FIG. 5. In an enterprise or commercial platform-as-a-service computing models (as described above), marketers of digital content subscription services who might wish to launch a video commenting feature would need to provision and maintain a level of system performance, reliability, and quality for each component in the delivery process—uploading, transcoding, moderating, publishing, and distribution—that would support both average and burst/peak utilization on a 24/7/365 basis. Such an approach may not be the most efficient, because much of the aggregated paid capacity of the system will be unutilized when no users happen to be generating video comments.

By contrast, with the micro-serverless subscription service such as that illustrated in FIG. 5, system capacity and performance can be triggered by events, such as a user sending a video comment upload request. The request to upload a video comment spawns a set of events performed by the serverless architecture. For example, as video comments are made, one event which can take place is adding each video comment moderation request to the moderation queue. As another example, the final event taking place in response to a video comment request can be the subscription service sending the user a response in the form of a secure upload location (an address to which the video will be uploaded), and before returning to a scaled-down listening mode where the system “listens” for commands from users. When the video arrives in the secure location, the subscription service will scale up the serverless architecture to handle transcoding the video into any number of renditions (e.g. for playback on different size mobile devices, connected TV playback, etc.).

At the same time, the subscription service can (via the serverless architecture) generate a thumbnail of the video such that when browsing a list of video comments, the particular video comment being uploaded can be identified. The serverless architecture can, upon finishing assigned tasks, emit a notification or other “event” signifying that the work of the serverless architecture with respect to that task is done before returning to its scaled-down listening mode. Additional events can be picked up by the moderation subsystems of the subscription service, which listen for events to occur.

In this manner, the subscription service can scale upwards and downwards as requests are moved in and out of the queue by incoming user requests and outgoing moderation actions. This kind of event-driven, near real-time workflow is exemplary not only of the remaining portions of publishing a video comment, but of all features supported by a micro-serverless subscription service in general. Besides supporting functionality as described here, and in addition to supporting a more efficient use of computing resources, the event stream generated by user and system actions within the micro-serverless subscription service can be harnessed to provide a rich environment for analytics, operations/processes, and data mining.

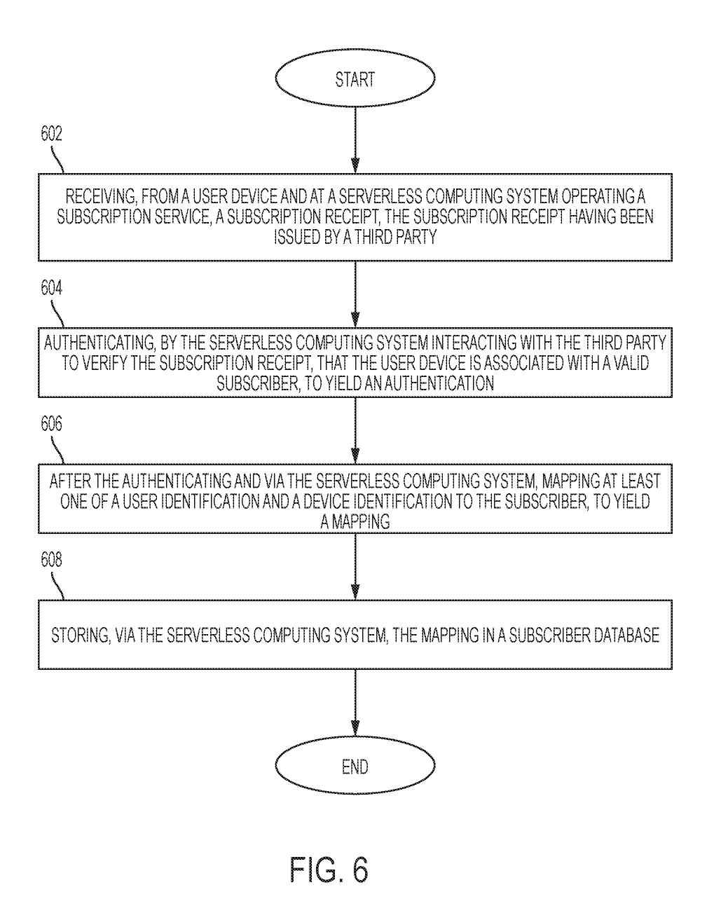

Consider how the serverless architecture of FIG. 5 can be used to execute the exemplary method of FIG. 6. Specifically, a serverless computing system operating a subscription service can be configured to receive, from a user device, a subscription receipt, the subscription receipt having been issued by a third party (602). Non-limiting examples of a third party include APPLE, AMAZON, SONY, MICROSOFT, ALPHABET, and GOOGLE. In some configurations, the user device receives the subscription receipt upon enrolling in the subscription service through the third party. The user device may be associated with a subscriber (that is, it is the subscriber's device).

The serverless computing system can authenticate the user device is associated with a valid subscriber by interacting with the third party to verify the subscription receipt, to yield an authentication (604) and, after the authenticating, map at least one of a user identification and a device identification to the subscriber, to yield a mapping (606). This mapping can be based on the authentication process. For example, the mapping can identify a relationship between a subscriber identification and the user device where the relationship was determined based on authenticating the subscriber. Such authentication can rely on third party Application Programming Interfaces (APIs). The serverless computing system can store the mapping in a subscriber database (608).

The serverless computing system can operate the subscription service without dedicated servers. For example, in various configurations, the subscription service can pay a computing service based on processing time for operations. For example, each time a user seeks to authenticate a subscription receipt, access content, etc., those operations utilize processing power. In such configurations, the subscription service would not be charged for time where the processor is idling or executing operations for other enterprises.

In some configurations, the exemplary method illustrated in FIG. 6 can be expanded. For example, the method may further include, after the mapping is stored in the subscriber database, performing a second authentication of the subscriber based on the mapping and recording information about the subscriber in the subscriber database based on the subsequent authentication. These statistics can similarly be recorded in the subscriber database. The method may also include granting access to subscription content when the authentication indicates that the user device is verified as being associated with a subscriber.

In another example, the method of FIG. 6 may be extended to include: receiving a video recording from the user device; verifying a subscription status based on the mapping; and forwarding, based on the subscription status, the video recording to a moderator. This can allow the serverless computing system to receive, from the moderator, approval of the video, and post the video on the subscription service.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media, or a computer-readable storage device, can include RAM, ROM, EEPROM, CD-ROM or other optical disk storage, magnetic disk storage or other magnetic storage devices, or any other device which can be used to carry or store desired program code means in the form of computer-executable instructions, data structures, or processor chip design.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply to subscription services for an individual as well as for companies, businesses, or other organizations. Various modifications and changes may be made to the principles described herein without following the example embodiments and applications illustrated and described herein, and without departing from the spirit and scope of the disclosure.

We claim:

1. A method comprising:
receiving, from a user device and at a serverless computing system operating a subscription service, a subscription receipt, the subscription receipt having been issued by a third party;
authenticating, by the serverless computing system interacting with the third party to verify the subscription receipt, that the user device is associated with a valid subscriber, to yield an authentication;
after the authenticating and via the serverless computing system, mapping at least one of a user identification and a device identification to the subscriber, to yield a mapping; and
storing, via the serverless computing system, the mapping in a subscriber database.

2. The method of claim 1, wherein the mapping at least one of the user identification and the device identification to the subscriber is further based on the authenticating.

3. The method of claim 1, wherein the user device receives the subscription receipt upon enrolling in the subscription service through the third party.

4. The method of claim 1, further comprising:
after the mapping is stored in the subscriber database, performing a subsequent authentication of the subscriber based on the mapping; and
recording information about the subscriber in the subscriber database based on the subsequent authentication.

5. The method of claim 1, further comprising:
granting access to subscription content when the authentication indicates that the user device is associated with the subscriber.

6. The method of claim 1, further comprising:
receiving a video recording from the user device;
verifying a subscription status based on the mapping; and
forwarding, based on the subscription status, the video recording to a moderator.

7. The method of claim 6, further comprising:
receiving, from the moderator, approval of the video; and
posting the video on a subscription service.

8. The method of claim 1, wherein the subscription service operates without dedicated servers.

9. The method of claim 1, wherein the subscription service pays a computing service based on processing time for operations.

10. The method of claim 1, wherein the third party is one of, or is associated with at least one of, Apple, Amazon, Google, Sony, Microsoft, and Alphabet.

11. A serverless subscription service configured to perform operations, the operations comprising:
receiving, from a user device, a subscription receipt, the subscription receipt having been issued by a third party;
authenticating, by interacting with the third party to verify the subscription receipt, that the user device is associated with a valid subscriber, to yield an authentication;
after the authenticating, mapping at least one of a user identification and a device identification to the subscriber, to yield a mapping; and
storing the mapping in a subscriber database.

12. The serverless subscription service of claim 11, wherein the mapping at least one of the user identification and the device identification to the subscriber is further based on the authentication.

13. The serverless subscription service of claim 11, wherein the user device receives the subscription receipt upon enrolling in the subscription service through the third party.

14. The serverless subscription service of claim 11, wherein the operations further comprise:
after the mapping is stored in the subscriber database, performing a subsequent authentication of the subscriber based on the mapping; and
recording information about the subscriber in the subscriber database based on the subsequent authentication.

15. The serverless subscription service of claim 14, wherein the operations further comprise:
calculating a lifetime value of a user associated with the subscriber based on the information about the subscriber.

16. The serverless subscription service of claim 11, wherein the operations further comprise:
granting access to subscription content when the authentication indicates that the user device is associated with the subscriber.

17. The serverless subscription service of claim 11, wherein the operations further comprise:
receiving a video recording from the user device;
verifying a subscription status based on the mapping; and
forwarding, based on the subscription status, the video recording to a moderator.

18. The serverless subscription service of claim 17, wherein the operations further comprise:
receiving, from the moderator, approval of the video; and
posting the video on a subscription service.

19. The serverless subscription service of claim 11, wherein the serverless subscription service pays a computing service based on processing time for the operations.

20. The serverless subscription service of claim 19, wherein the computing service is, or is associated with, Amazon.
